(19) United States
(12) Patent Application Publication
(10) Pub. No.: US 2026/0363177 A1
(43) Pub. Date: Nov. 19, 2026

(54) AGRICULTURAL MACHINE WITH AN AUGER AND A PRODUCT DEFLECTOR

(71) Applicant: KUHN SAS, Saverne (FR)

(72) Inventor: Thomas BRUYEN, Hangviller (FR)

(73) Assignee: KUHN SAS, Saverne (FR)

(21) Appl. No.: 19/658,824

(22) Filed: Apr. 27, 2026

(30) Foreign Application Priority Data
May 14, 2025 (FR) FR2505096

(51) Int. Cl. A01D 57/30; A01D 43/04

(52) U.S. Cl. CPC A01D 57/30; A01D 43/04

(57) ABSTRACT

The invention relates to a haymaking machine including a chassis and a unit articulated to the chassis, as well as a harvesting device for harvesting a plant product and a conveyor for forming a windrow with the harvested product, and including an auger that can be driven in rotation around an axis of rotation and having a coil, wherein a guide box extends at least partially under and behind the auger, the box having a radial opening located behind a portion of the auger adjacent to the inner end of the coil, the machine includes a deflector at least partially located behind the auger, and wherein the deflector has at least one deflecting surface oriented transversely to the axis of rotation.

### BACKGROUND OF THE INVENTION

### Field of the Invention

The present invention relates to the field of agricultural machinery and concerns an agricultural haymaking machine including an auger and a product deflector.

More specifically, the invention relates to a haymaking machine including a chassis and at least one unit articulated to the chassis and including a harvesting device for harvesting a plant product, and a conveyor for forming a windrow with the harvested product and including an auger that can be rotated about an axis of rotation and has at least one coil, a guide box extending at least partially under and behind the auger, the box having a radial opening located behind a portion of the auger adjacent to the inner end of the or each coil.

### Description of the Related Art

Such a haymaking machine is known from document EP 2 829 168 A1. On this machine, at least one wall of the guide box can be removed, creating a radial opening located behind the portion of the auger adjacent to the inner end of the coil. The product located in front of the opening thus formed can then be ejected radially from the conveyor through this radial opening. Such a machine can thus form a narrow central windrow when the box has no opening behind and below the auger, and a wider windrow when at least one wall is removed.

A drawback of the machine described in document EP 2 829 168 A1 is that the quantity of product passing through the radial opening—when at least one wall is removed—is not constant but may depend in particular on the quantity and/or volume of product present in the box, so that the width and shape of the windrow may vary. Another drawback of this machine is the overall dimensions of the removable wall(s), their weight, and the time required to assemble, disassemble, and/or move them. Furthermore, tests carried out on a machine similar to that described in document EP 2 829 168 A1, with a box that does not have an opening behind the auger, have shown that the product is ejected axially with such force that it causes the product to be projected away from the machine, sometimes beyond the desired width of the windrow. The windrow obtained may therefore be wider than desired, which may mean that some of the product is not collected by the harvesting machine, resulting in product loss and therefore lower quality work. In cases where the machine deposits the product on top of and/or next to a windrow that has already been formed and is present on the ground, for example by a front unit, the force of the product flow may also be such that it deforms this previously formed windrow, resulting in an irregular windrow that is difficult to collect. Finally, in the case of a machine with two conveyors carrying product flows in opposite directions, the meeting of these opposing flows can cause the product to scatter, resulting in greater losses and an even more heterogeneous windrow.

Document EP 3 332 628 A1 also describes a machine similar to the one described in the introduction. On this machine, a deflector located under the chassis dampens or stops the axial flow and prevents the product from being ejected too far along the axis of rotation, keeping the windrow below a desired width. One drawback of this design is the location of the deflector, under the chassis, particularly in combination with the fact that it extends significantly to the ground. Such a deflector is at risk of being damaged and/or damaging the ground when the machine is moved over uneven ground. In the event that the machine is supposed to deposit its windrow on top of and/or next to another windrow that has already been formed and is present on the ground, such a deflector may also undo or disrupt the windrow on the ground, making it more heterogeneous and complicating its collection.

### SUMMARY OF THE INVENTION

The purpose of the present invention is to provide an alternative to the aforementioned existing solutions. It also aims to overcome at least some of the aforementioned drawbacks. To this end, the invention proposes an agricultural machine according to claim 1. Various embodiments and the preferred embodiment are explained in this description with reference to the accompanying figures, in which:

### BRIEF DESCRIPTION OF THE DRAWINGS

FIG. 1 shows a haymaking machine according to the preferred embodiment of the invention with two side units, viewed from above;

FIG. 2 shows a side unit viewed from behind, in an outer position of the deflector, in a simplified version (without rear protection or folding wall);

FIG. 3 shows a detailed view of a side unit of the machine in FIG. 1, viewed from behind and in an inner position of the deflector;

FIG. 4 shows the side unit of FIG. 3, following the section shown in FIG. 3, viewed along the axis of rotation of the auger, in another position of the deflector;

FIG. 5 shows a machine viewed from behind and in the forward direction, according to a second embodiment in which a deflector is located behind each conveyor coil.

### DETAILED DESCRIPTION OF THE PREFERRED EMBODIMENTS

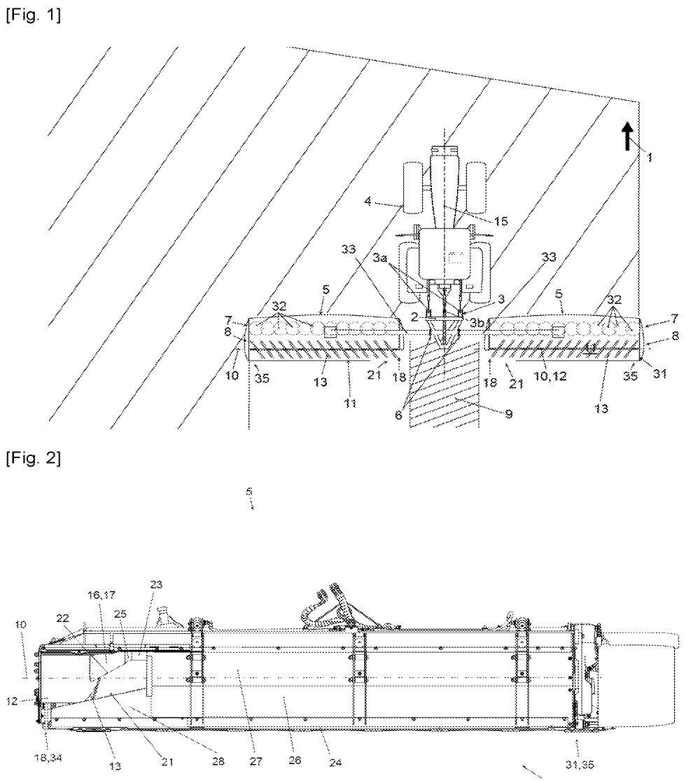

As shown in FIG. 1, the haymaking machine according to the invention can move in a forward direction 1 during operation. This haymaking machine includes a chassis 2. In FIG. 1, the chassis 2 includes a coupling device 3 at its front end. The coupling device 3 allows the chassis 2 to be connected to an agricultural tractor 4.

The machine, respectively the chassis 2, has a central plane 15. At least one of the machine, the chassis 2, and the tractor 4 is substantially symmetrical with respect to the central plane 15, and preferably all three are. The or each coupling device 3 has two lower pins 3a and an upper pin 3b. The coupling device 3 can be connected to the three-point hitch of the tractor 4 by the lower pins 3a and the upper pin 3b. Alternatively, the coupling device 3 can be connected to the tractor 4 by a simple pivot pin. The central plane 15 passes through the upper pin 3b of the three-point hitch of the tractor 4. The central plane 15 is vertical. The central plane 15 is also parallel to the forward direction 1.

The machine includes at least one unit 5, 5'. In the preferred embodiment of FIG. 1, each unit 5, 5' is a side unit 5. A side unit 5 is offset laterally relative to the chassis 2 as viewed in the forward direction 1. Preferably, the or each side unit 5 is also offset laterally relative to the tractor 4 as viewed in the forward direction 1. The or each side unit 5 is located at the rear of the tractor 4. In particular, in order to ensure good ground tracking, each unit 5, 5' is articulated with the chassis 2. Simply put, the side unit 5 is mounted so that it pivots with the chassis 2 along a lifting axis 6 that is substantially parallel to the forward direction 1.

In this document, the term “width” refers to the dimension measured perpendicular to the forward direction 1 and horizontally. In this document, the orientations are defined for a machine on a flat, horizontal surface. Thus, the line passing through the lower pins 3a is substantially horizontal. In this document, the term “rear” should be considered in relation to the forward direction 1, and the terms “inner” and “outer” should be considered in relation to the central plane 15. In other words, an inner part is closer to the central plane 15 than an outer part. Furthermore, “rearwardly inclined” essentially means that the rear end is located higher than the front end of the part in question. It should also be noted that “viewed in the forward direction 1” means standing behind the machine when looking in the forward direction 1.

Each unit 5, 5' includes a harvesting device 7 for harvesting a plant product. The product is preferably grass. The product may be on the ground and/or still standing. Each unit 5, 5' also has a conveyor 8. The conveyor 8 forms a windrow 9 with the harvested product (by the harvesting device 7) so that it can be collected more quickly by a gathering machine such as a baler or a loader wagon. The tractor 4 is used to move the machine. The tractor 4 is also the power source for driving the harvesting device 7 and/or the conveyor 8. In an alternative embodiment not shown, the chassis 2 and the unit(s) 5, 5' are part of a self-propelled machine.

The conveyor 8 includes an auger 11 that can be rotated around an axis of rotation 10. The auger 11 has a core 12. The core 12 is a cylinder, preferably straight circular, centered around the axis of rotation 10. In order to move the product along the axis of rotation 10, the auger 11 has at least one coil 13, preferably helical. The or each coil 13 is oriented so as to move the product inward (toward the auger 11) when the auger 11 is rotated. Respectively, the or each coil 13 is arranged to move the product toward the central plane 15.

In order to keep the product close to the auger 11 and thus ensure its movement, the conveyor 8 also includes a guide box 14 extending at least partially under and behind the auger 11. The auger 11 is located just behind the respective harvesting device 7, facilitating the collection of the harvested product by the harvesting device 7 and thus preventing losses.

During normal operation, the harvesting device 7 transfers the harvested product to the conveyor 8, which moves it along the axis of rotation 10. The axis of rotation 10 is transverse to the forward direction 1. In order to maximize the working width of the machine, respectively of the unit 5, 5', the axis of rotation 10 is preferably perpendicular to the forward direction 1. The axis of rotation 10 is horizontal and/or parallel to the ground. In the first and preferred mode, the box 14 has an axial opening 18 at its inner end in line with the auger 11, allowing the product to be deposited laterally, respectively behind the chassis 2 and/or the tractor 4. On a side unit 5, the auger 11 thus generates a flow of product and ejects at least part of the product through the axial opening 18. The axial opening 18 extends at least substantially vertically. Preferably, the axial opening 18 extends along a plane perpendicular to the axis of rotation.

The box 14 keeps the product close to the auger 11 until it is ejected. The flow generated by the auger 11 is oriented substantially along the axis of rotation 10. When ejected from a side unit 5, the product flow is oriented transversely to the forward direction 1. When the product lands on the ground, it forms a windrow 9. Thanks to the movement of the machine, the windrow 9 extends parallel to the forward direction 1. A side unit 5 is arranged so as to form a windrow 9 behind the chassis 2 and/or the tractor 4, reducing the risk of running over the windrow 9 with the tractor 4 and/or passing over the windrow 9 with the machine during a subsequent pass.

The box 14 includes at least one wall 24, 26, 27, 28 located below and/or behind the auger 11. Each of the walls 24-28 extends parallel to the axis of rotation 10. Viewed along the axis of rotation 10, the outer trajectory 19 of the auger 11 when driven is circular. In order to allow the auger 11 to move the product contained in the box 14, the box 14 follows the trajectory 19. In other words, each wall 24-28 is close to the trajectory 19. Each wall 24-28 is located less than three centimeters from the trajectory 19, and preferably less than one centimeter from the trajectory 19. In order to allow the product to pass through, no wall 24-28 extends between the harvesting device 7 and the conveyor 8.

As shown in FIG. 1, the or each coil 13 has an inner end 34 and an outer end 35. The inner end 34 of a coil 13 is closer to the central plane 15 than its outer end 35.

In order to contain the product and reduce the risk of product loss, the box 14 includes at least one outer partition 31 extending perpendicularly to the axis of rotation 10 and located at least at one or at the outer end of the auger 11.

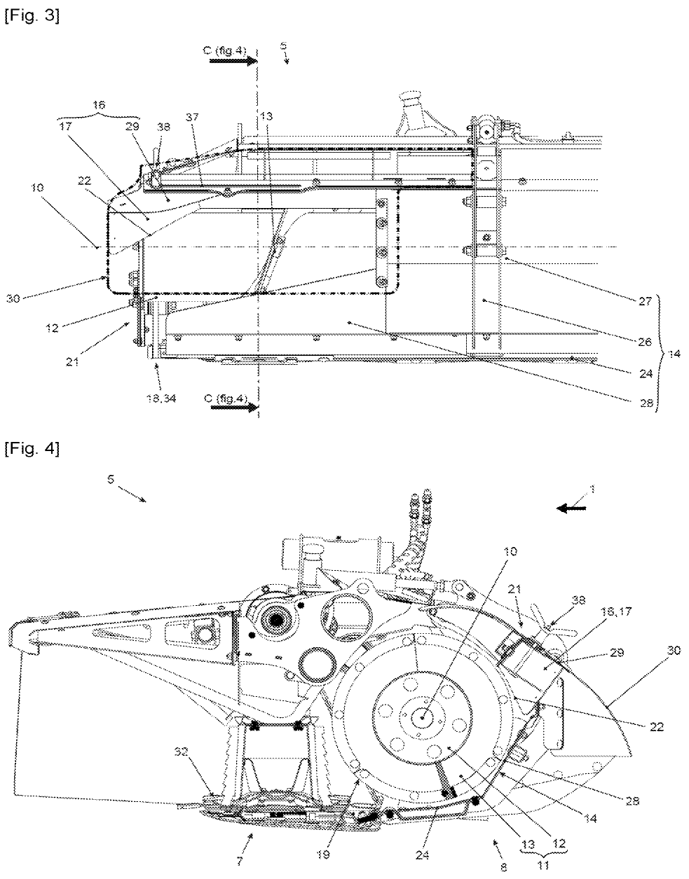

As shown in FIG. 2, in order to obtain a wide windrow 9 and reduce the risk of clogging in the box 14, the box 14 does not extend behind the portion of the auger 11 adjacent to the inner end 34 of the or each coil 13. In other words, the box 14 has a radial opening 21 located behind a portion of the auger 11 adjacent to the inner end 34 of the or each coil 13. As shown in FIGS. 2, 3, and 5, the radial opening 21 is located behind the auger 11. The radial opening 21 is also located near the inner end 34 of the or each coil 13. The portion of the auger 11 adjacent to the inner end 34 of the or each coil 13 extends from the inner end 34 of the coil 13 in question towards the outer end 35 of the coil 13 in question. Thus, viewed in the forward direction 1, the radial opening 21 extends preferably from the inner end 34 toward the outer end 35 of the associated coil 13. In this way, at least part of the product moved by the auger 11 can pass through and/or be ejected from the machine through this radial opening 21. The radial opening 21 extends parallel to the axis of rotation 10, and preferably substantially vertically. In order to prevent product from becoming caught, with a lateral unit 5, the axial opening 18 and the radial opening 21 form a single opening.

In this document, a jam is an accumulation of product that blocks its flow, namely the movement of product, particularly in the box 14. A jam requires manual human intervention, which can sometimes be difficult and time-consuming, to unblock the machine, namely the box 14. Finally, a jam can cause damage to the machine.

According to the invention, the machine includes a deflector 16 that is at least partially located behind the auger 11. In addition, the deflector 16 has at least one deflecting surface 17 oriented transversely to the axis of rotation 10. Such a deflector 16 allows part of the harvested product to be deflected before it reaches the inner end 34 of the coil 13 and deposited further out, thus forming a wider windrow. To simplify matters, the portion of the product deflected by the deflector 16 is referred to as the “deflected flow,” and the portion not deflected by the deflector 16 is referred to as the “axial flow.” The deflector 16 makes the deflected flow more constant and/or the ratio between deflected flow and axial flow more constant, resulting in a more homogeneous and/or more regular-shaped windrow 9. Another advantage of such a deflector 16 is that the axial flow is lower than without a deflector 16, thereby reducing the force of this flow and the risk of ejecting product too far, thus avoiding losses and/or a windrow 9 that is wider than desired. In the event that the product, namely the windrow 9, is deposited on top of and/or next to another windrow that has already been formed and is present on the ground, reducing the force of the axial flow also prevents deformation of this previously formed windrow, further reducing the risk of product loss and resulting in a more regular and uniform overall windrow. Finally, in the case of side units 5, such a deflector 16 prevents cluttering of the area located under and/or behind the chassis 2.

One or each deflector 16 could have several deflecting surfaces 17 oriented differently. In a simple and economical manner, the or each deflector 16 has a single deflecting surface 17. In order to simplify the manufacture of the deflector 16 and reduce its cost price, the deflecting surface 17 is preferably flat. The deflecting surface 17 may be made of sheet metal, for example. Alternatively, the deflecting surface 17 could be curved, for example when viewed in the forward direction 1.

As shown in the figures, each coil 13 is preferably associated with a deflector 16. This design allows each coil 13 to obtain, where applicable, at least some of the advantages of the deflector 16 as described above. FIGS. 2, 3, and 5 show that the or each deflector 16 is located close to the inner end 34 of the associated coil 13, allowing a windrow to be formed close to the inner end 34 of the coil(s) 13.

The or each box 14 has at least one bottom wall 24 extending below the axis of rotation 10. Preferably, one bottom wall 24 is associated with each auger 11. The or each bottom wall 24 extends below and preferably across the entire width of the associated auger 11.

The or each box 14 has at least one lower wall 26 extending behind the axis of rotation 10. Preferably, one lower wall 26 is associated with each coil 13. The lower wall 26 extends below and behind the associated coil 13. The lower wall 26 extends from the outer end 35 of the associated coil 13 to the radial opening 21. The lower wall 26 extends at least over half, and more preferably over at least three quarters, of the width of the associated coil 13.

The or each box 14 comprises at least one upper wall 27 extending behind the axis of rotation 10. Preferably, an upper wall 27 is associated with each coil 13. The upper wall 27 extends above and behind the associated coil 13. In order to form the radial opening 21, the upper wall 27 preferably does not extend across the entire width of the associated coil 13. The upper wall 27 extends from the outer end 35 of the associated coil 13 to the radial opening 21. The upper wall 27 extends at least over half, and more preferably at least over three quarters, of the width of the associated coil 13. Economically, each wall 24-28 is made of at least one plate, preferably a metal sheet. In order to reduce the risk of jamming, the width of the radial opening 21 is preferably greater than one-eighth, and more preferably greater than one-sixth, of the width of the associated coil 13.

In order to prevent product loss, the box 14 is adjacent to the harvesting device 7. More specifically, the bottom wall 24, namely its front end, is adjacent to the harvesting device 7. Again, in order to prevent product loss, the bottom wall 24, namely its rear end, is adjacent to the lower wall 26, namely the front end of the lower wall 26. Finally, the upper wall 27, namely its rear end, is attached to the lower wall 26, namely its rear end. Finally, the upper wall 27 extends preferably up to above the auger 11.

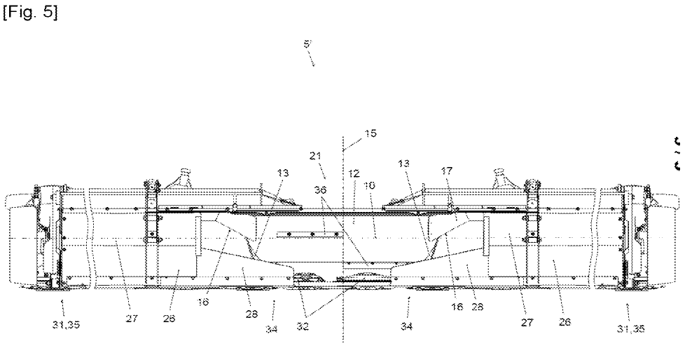

In order to deflect at least part of the product through the radial opening 21 and prevent jamming, as shown in FIGS. 2 and 5, the or each deflecting surface 17 is located at least partially within the radial opening 21 as viewed in the forward direction 1. In other words, the deflecting surface 17 is located between the inner end of the upper wall 27 and the inner end 34 of the associated coil 13. At least in the outer position of the deflecting surface 17 (see below), the deflecting surface 17 is located between the inner end of the upper wall 27 and the inner end of the associated coil 13. Preferably, the deflecting surface 17 is also located at least partially in the radial opening 21 as viewed along the axis of rotation 10.

The deflecting surface 17 has a dividing portion 22. As shown in FIG. 4, the dividing portion 22 is the portion of the deflecting surface 17 closest to the auger 11. In FIGS. 3 and 4, the dividing portion 22 is an edge of the deflecting surface 17. Viewed along the axis of rotation 10, the dividing portion 22 is substantially tangential to the trajectory 19. In order to avoid any friction between the deflector 16 and the auger 11 while following the trajectory 19, as viewed along the axis of rotation 10, the dividing portion 22 is preferably parallel to the tangent to the trajectory 19 passing through the point on the trajectory 19 closest to the dividing portion 22. The dividing portion 22 is obviously located outside the trajectory 19. Since the point on the trajectory 19 closest to the dividing portion 22 is located behind and above the auger 11, in order to best follow the trajectory 19, the dividing portion 22 is inclined forward. Preferably, as illustrated in FIG. 4, the dividing portion 22 forms an angle between 5° and 55° with the vertical, and more preferably between 15° and 45°.

As shown in FIG. 2 in particular, since the point on the trajectory 19 closest to the dividing portion 22 is located behind and above the auger 11, in order to reduce the risk of jamming, the dividing portion 22 is also inclined outward. The dividing portion 22 forms an angle between 5° and 55°, and more preferably between 15° and 45°, with the axis of rotation 10, viewed in the forward direction 1. Alternatively, the dividing portion 22 could be helical, allowing the distance between the dividing portion 22 and the trajectory 19 to be more constant, viewed along the axis of rotation 10.

In order to allow the deflector 16 to deflect as much of the product located inside the box 14 as possible, the dividing portion 22, namely the deflector 16, is located less than three centimeters from the trajectory 19, and more preferably less than one centimeter from the trajectory 19. In fact, the further the dividing part 22 is from the auger 11, or from the trajectory 19, the less the deflector 16 deflects the product. Also, the further the dividing portion 22 is from the auger 11, the less the flow deflected by the deflector 16 is significant.

As shown in FIG. 4, in order to deflect the flow toward the ground, the deflecting surface 17 is inclined backward. Respectively, the front end of a side edge of the deflecting surface 17 is lower than the rear end of the side edge in question. Tests have shown that a good windrow 9 shape is obtained when the angle between the deflecting surface 17 and the ground, viewed along the axis of rotation 10, is between 30° and 60°, and more preferably between 40° and 50°. Alternatively, the deflecting surface 17 could be oriented so that its side edges are horizontal.

As shown in the figures, in order to reduce the overall dimensions of the deflector 16, respectively the deflecting surface 17, the deflecting surface 17 is located at least mainly above the axis of rotation 10, allowing the deflector 16 to be moved away from the ground, reducing the risk of damaging the ground and/or the deflector 16 when the machine is moving over uneven ground, as well as the risk of undoing a previously formed windrow, if applicable.

In a first embodiment, the machine includes a single side unit 5, preferably on the right side of the central plane 15. In order to provide a greater working width and thus increase the speed of agricultural work, in the preferred embodiment, the machine includes two side units 5, namely a right side unit 5 and a left side unit 5 mounted symmetrically with respect to the central plane 15. Each of the side units 5 is arranged so as to deposit the product between the two side units 5. Thus, the axial flow of each conveyor 8 is in the opposite direction. Because at least one axial flow is reduced, the impact between the two opposing axial flows is less, further reducing the risk of product loss and improving the shape and homogeneity of the overall windrow 9. Preferably, each side unit 5 is associated with a single coil 13 and a single deflector 16.

In a second embodiment shown in FIG. 5, the machine includes a single front unit 5'. The front unit 5' is mounted on the front hitching device of the tractor 4. The chassis 2 of a front unit 5' has a coupling device 3 at its rear end. Preferably, the front unit 5' is centered on the central plane 15. The front unit 5' preferably deposits a windrow 9 centered on the auger 11 (and centered on the central plane 15). In this second mode, the box 14 preferably has no axial opening 18. In the second mode, the box 14 has two outer partitions 31, each located at a lateral end of the auger 11.

The embodiments may be combined. A machine according to the preferred embodiment or the first embodiment may thus also include a front unit 5' or be used simultaneously with a machine including a front unit 5', implying that the windrow 9 deposited by the side unit(s) 5 is deposited on and/or next to the windrow previously formed by the front unit 5'. When the side unit(s) 5 deposit the windrow 9, the windrow previously formed by the front unit 5' is present on the ground.

In order to center the windrow, two coils 13 are preferably associated with the auger 11 of a front unit 5'. As shown in FIG. 5, the two coils 13 are oriented differently. In order to direct the flow from each coil 13 towards the central plane 15, the coils 13 are symmetrical with respect to the central plane 15. Also, each coil 13 is preferably located on a respective side of the central plane 15. In the case of a front unit 5', the product is deposited in front of the front wheels of the tractor 4.

With a front unit 5', each coil 13 extends from an outer end of the front unit 5' toward the central plane 15. In order to avoid product losses due to dispersion when the flows ejected by each coil 13 of an auger 11 of a front unit 5' meet, each coil 13 preferably does not extend inwardly to the central plane 15. The outer end 35 of each coil 13 is located near the outer end of the auger 11. In the second embodiment, the radial opening 21 also extends between the inner ends 34 of each coil 13 when viewed in the forward direction 1. Between the inner ends 34 of each coil 13, the core 12 of the auger 11 is continuous.

In order to project at least part of the plant product in the opposite direction to the forward direction 1, the auger 11 of a front unit 5' preferably includes blades 36 oriented radially with respect to the axis of rotation 10 and located at least partially between the inner ends 34 of each coil 13. For the same purpose, the outer end of at least one blade 36 is located close to the inner end 34 of at least one coil 13. The blades 36 are distributed around the perimeter of the core 12, preferably uniformly.

In a first embodiment alternative, the deflector 16 is fixed relative to the box 14. Additionally or alternatively, in order to allow the user to choose between forming a wide windrow 9 and a narrow windrow 9, the deflector 16 may be removable. In order to obtain a wide windrow 9, the deflecting surface 17 is located close to the outer end of the radial opening 21 (FIG. 2). When the deflector 16 is removed, the associated conveyor 8 forms a narrow windrow 9. However, a drawback of this first alternative is that the advantages of the deflector 16 are only available when it is installed. Also, in this first alternative, the user must manually install and remove the deflector 16 to change the width of the windrow 9.

In order exploit the advantages of the deflector 16 for forming a wide windrow 9 and for forming a narrow windrow 9, the deflector 16 can occupy at least two axial positions. As shown in FIG. 2, the deflector 16 occupies an outer position. In the outer position of the deflector 16, the deflecting surface 17 is located close to the outer end of the radial opening 21. In the outer position of the deflector 16, the deflecting surface 17 is also further away from the central plane 15 than the inner end 34 of the respective coil 13. As shown in FIG. 3, the deflector 16 can occupy an inner position. In the inner position of the deflector 16, the deflecting surface 17 is closer to the central plane 15 than in its outer position. In the inner position of the deflector 16, the deflecting surface 17 is preferably located behind the inner end 34 of the associated coil 13, viewed in the forward direction 1. Also, in the inner position of the deflector 16, the deflecting surface 17 is located in the axial opening 18, viewed in the forward direction 1. Thus, the deflecting surface 17 can be located in the axial opening 18 as viewed in the forward direction 1, which increases the possible widths of the windrow 9 deposited by the associated unit 5, 5'. In fact, the greater the amplitude of translation of the deflecting surface 17, the greater the possible variation in the width of the windrow 9.

In a second embodiment alternative, the or each deflector 16 can only occupy two positions. In order for the user to be able to adjust the width of the windrow 9 deposited by the or each conveyor 8, or the overall width of the windrow 9, the or each deflector 16 can preferably occupy a multitude of axial positions. Thus, the or each deflector 16 can preferably translate parallelly to the axis of rotation 10.

Therefore, regardless of the position of the or each deflector 16, the box 14 always has a radial opening 21, which advantageously reduces the risk of jamming in the box 14 and the risk of clumping, and improves the shape and uniformity of the windrow 9 in all positions of the deflector 16. The deflecting surface 17 is thus such that it never completely obstructs the radial opening 21. In other words, the area of the deflecting surface 17 is much smaller than the area of the radial opening 21. As shown in FIG. 3, the width of the deflecting surface 17 is preferably less than half the width of the radial opening 21. Similarly, the height of the deflecting surface 17 is less than the height of the radial opening 21.

In order to hold the deflector 16 in position, as shown in FIGS. 2 and 3, at least one oblong hole 37 oriented parallel to the axis of rotation 10 may be provided in the box 14. Preferably, a bolt 38 is used to release or lock this sliding connection. Alternatively, the movement of the deflector 16 and its holding in position could be ensured by a jack.

In order to prevent the deflector 16 from pivoting relative to the box 14, a projection integral with the deflector 16 may be mounted so as to slide in an elongated hole provided in the box 14 and oriented parallel to the axis of rotation 10. This elongated hole may be a second oblong hole parallel to the axis of rotation 10 and made in the box 14. Put simply, the elongated hole is the oblong hole 37.

The radial opening 21 is at least partially limited downwardly by at least one retaining wall 28. In order to guide the axial flow at least to the inner end 34 of the or each coil 13, the box 14 includes at least one retaining wall 28. Preferably, a retaining wall 28 is associated with each coil 13. The or each retaining wall 28 extends behind and below the portion of the auger 11 adjacent to the inner end 34 of the associated coil 13. The or each retaining wall 28 also extends under the radial opening 21 as viewed in the forward direction 1. Such a retaining wall 28 allows for a clear separation of the axial and deflected flows, contributing to the production of a more uniform windrow 9.

The retaining wall 28 is located in line with the lower wall 26. The retaining wall 28 extends from the inner end 34 of the associated coil 13 to the outer end of the radial opening 21, respectively to the lower wall 26. With a lateral unit 5, the retaining wall 28 extends over the same width as the radial opening 21. In order to allow the flow deflected by the radial opening 21 to pass through while maintaining the axial flow under the auger 11, the retaining wall 28 is located entirely below the axis of rotation 10 as viewed in the forward direction 1. In order to allow more product to pass through the radial opening 21, the or each retaining wall 28 may have an upper edge inclined outward, reducing jamming.

The radial opening 21 may extend over the entire height of the box 14. In the second embodiment, the radial opening 21 extends over the entire height of the box 14 between the retaining walls 28. Thus, in the second embodiment, the radial opening 21 also extends between the two retaining walls 28. In the case of a side unit 5, the radial opening 21 preferably does not extend lower than the auger 11.

In order to reduce the overall dimensions of the deflector 16, the height of the deflecting surface 17 is less than the height of the radial opening 21. Preferably, the height of the deflecting surface 17 is less than two-thirds of the height of the radial opening 21.

In order to allow a significant amount of product to pass through, the width of the radial opening 21 is preferably greater than one-tenth, and more preferably greater than one-seventh, of the width of the respective side unit 5. In order to avoid losses while allowing a wide windrow to be obtained, the width of the radial opening 21 is less than one-fifth, and more preferably one-third, of the width of the respective side unit 5.

In order to allow a significant quantity of product to pass through, the radial opening 21 extends over a height substantially equal to the diameter of the auger 11. The radial opening 21 extends at least over a height greater than half the diameter of the auger 11.

In order to best match the trajectory 19, each of the bottom wall 24, lower wall 26, upper wall 27, and retaining wall 28 is parallel to a tangent of the trajectory 19 passing through the point on the trajectory 19 closest to the respective wall 24-28.

In order to prevent product loss from the deflected flow, the deflector 16 slides along a guide surface 23 integral with the box 14 as it moves along the axis of rotation 10. In order to prevent product intrusion between the deflecting surface 17 and the guide surface 23, a flexible wall 25 can be attached to the deflecting surface 17 so as to come into contact with the guide surface 23. The flexibility of the flexible wall 25 reduces friction.

As shown in FIG. 3, in order to prevent product deflected by the deflector 16 from being carried above the deflecting surface 17, the or each deflector 16 preferably has a lowering surface 29 located above the deflecting surface 17. The lowering surface 29 is attached to the deflecting surface 17. In order to allow the deflector 16 to effectively fold the product toward the ground, the lowering surface 29 is preferably inclined forward. Thus, the lowering surface 29 has a rear end that is lower than its front end. In order to simplify the manufacture of the deflector 16 and reduce its cost price, the lowering surface 29 is flat and preferably made of sheet metal. In a simplified embodiment alternative shown in FIG. 2, the deflector 16 does not have a lowering surface 29 above the deflecting surface 17.

As shown by the dotted line in FIG. 3, in order to prevent stones or any solid objects from being projected through the radial opening 21, which could injure someone, the machine preferably includes a guard 30 located behind the radial opening 21 as viewed in the forward direction 1. As shown in FIG. 4, the guard 30 extends from the top of the box 14 to a certain distance behind the radial opening 21, thus allowing the product to pass through the radial opening 21. Respectively, the guard 30 extends from the top of the box 14 to a certain distance behind the retaining wall 28, further lowering the product that has passed through the radial opening 21. Preferably, the guard 30 extends in line with the lowering surface 29 as viewed along the axis of rotation 10. As shown in FIG. 3, the width of the guard 30 is preferably slightly greater than that of the radial opening 21. Also, the height of the guard 30 is preferably slightly greater than that of the radial opening 21. For ease of understanding, in FIG. 3, the surface of the guard 30 is either obscured or transparent. In the second embodiment, the guard 30 may extend across the entire width of the radial opening 21 (along the axis of rotation 10). Alternatively, in the second embodiment, each deflector 16 is associated with a respective guard 30 extending substantially over the same width as the respective retaining wall 28.

The or each side unit 5 can occupy a working position in which it rests on the ground. In its working position, the side unit 5 allows product to be harvested. In order to reduce the width of the machine, the or each side unit 5 can also occupy a raised position not shown. In its raised position, the side unit 5 does not process any product. In order to change position quickly and easily, the side unit 5 can pivot between its working position and its raised position around the lifting axis 6. In this document, unless otherwise stated, the orientations and positions are given when the unit 5, 5' is in the working configuration.

The fact that the deflecting surface 17 is located behind the auger 11, and in particular not between the auger 11 and the central plane 15, thus makes it possible to increase the ground clearance when a side unit 5 is in its raised position. Ground clearance is the distance between the ground and the machine, or the minimum distance between the ground and the machine. Increasing ground clearance therefore prevents the machine from catching on windrows when it moves over windrows 9 on the ground, with the side unit or units 5 in the raised position.

Preferably, the haymaking machine is a mower. The harvesting device 7 is then a cutter bar comprising disks 32, each of which is driven in rotation around a respective vertical drive shaft during operation. Rotary blades are mounted on the periphery of these disks 32 and may protrude beyond said periphery in order to mow vegetation as they rotate. In order to reduce blade wear, each blade is preferably mounted so as to pivot with the respective disk 32 around a respective vertical axis.

In order to simplify the machine and reduce its weight and cost price, the machine is preferably a simple mower with no conditioner rotor or lifting rotor. Alternatively, each side unit 5 has a conditioner rotor located between the harvesting device 7 and the conveyor 8. Alternatively or additionally, each side unit 5 has a pickup-type lifting rotor for picking up product on the ground. Alternatively, the machine could be a rake whose harvesting device 7 has a pickup-type lifting rotor.

In order to avoid any loss of product during transfer between the harvesting device 7 and the auger 11, the auger 11 is preferably driven so that the front of the auger 11 rotates downward. For this same reason, the plane passing through the drive axes of the disks 32 is preferably parallel to the axis of rotation 10. In FIG. 1, the disks 32 are represented by their respective outer trajectories as they rotate around their respective axes of rotation.

As shown in FIG. 1 in particular, a support arm 33 is associated with each side unit 5. At its inner end, the arm 33 is articulated on the chassis 2, at least around the respective lifting axis 6. At its outer end, the arm 33 is connected to the respective side unit 5, preferably by an articulation parallel to the lifting axis 6. In the working position of the unit 5, the arm 33 is substantially horizontal. Preferably, in the raised position of the side unit 5, the arm 33 is substantially vertical, reducing the width of the machine.

Of course, the invention is not limited to the embodiments described and shown in the accompanying drawings. Modifications remain possible, particularly in terms of the composition of the various elements or by substituting technical equivalents, without departing from the scope of protection of the invention.

1. A haymaking machine including a chassis and a unit articulated to the chassis and including a harvesting device for harvesting a plant product, and a conveyor for forming a windrow with the harvested product and including an auger that can be rotated about an axis of rotation and the auger having a coil, wherein a guide box extends at least partially under and behind the auger, the box having a radial opening located behind a portion of the auger adjacent to the inner end of the or each coil,
wherein the machine includes a deflector that is at least partially located behind the auger, and wherein the deflector has a deflecting surface oriented transversely to the axis of rotation.

2. The machine according to claim 1, wherein a deflector is associated with each coil and located close to the inner end of the associated coil.

3. The machine according to claim 1, wherein the or each deflecting surface is located at least partially within the radial opening as viewed in the forward direction.

4. The machine according to claim 1, wherein the deflecting surface is inclined backward.

5. The machine according to claim 1, wherein the deflecting surface is located at least mainly above the axis of rotation.

6. The machine according to claim 1, wherein a retaining wall is associated with each coil, wherein the or each retaining wall extends behind and below the portion of the auger adjacent to the inner end of the associated coil and under the radial opening as viewed in the forward direction.

7. The machine according to claim 1, wherein the deflector can translate parallelly to the axis of rotation.

8. The machine according to claim 1, wherein the or each deflector has a lowering surface located above the deflecting surface and inclined forward.

9. The machine according to claim 1, wherein the box has an axial opening at its inner end in line with the auger, and the deflecting surface can be located in the axial opening at least viewed in the forward direction.

10. The machine according to claim 6, wherein the radial opening also extends between the two retaining walls.
